(19) United States
(12) Patent Application Publication
(10) Pub. No.: US 2007/0216376 A1
(43) Pub. Date: Sep. 20, 2007

(54) Semiconductor integrated circuit and system guaranteeing proper operation under low-temperature condition

(75) Inventor: Toshio Ogawa, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/505,439

(22) Filed: Aug. 17, 2006

(30) Foreign Application Priority Data
Mar. 20, 2006 (JP) 2006-076778

(51) Int. Cl. G05F 1/10

(52) U.S. Cl. 323/236

(57) ABSTRACT

A semiconductor integrated circuit includes a measurement circuit configured to detect a measuring quantity dependent on temperature, and a heating circuit configured to generate heat in response to a detection, by the measurement circuit, of the measuring quantity indicating that the temperature is lower than a predetermined level.

### CROSS-REFERENCE TO RELATED APPLICATIONS

The present application is based upon and claims the benefit of priority from the prior Japanese Patent Application No. 2006-076778 filed on Mar. 20, 2006, with the Japanese Patent Office, the entire contents of which are incorporated herein by reference.

### BACKGROUND OF THE INVENTION

1. Field of the Invention

The present invention generally relates to semiconductor integrated circuits, circuit systems, and methods of driving a semiconductor integrated circuit, and particularly relates to a semiconductor integrated circuit, a circuit system, and a method of driving a semiconductor integrated circuit wherein circuit operations at low temperature are required.

2. Description of the Related Art

As the development of semiconductor technology leads to the size reduction of semiconductor integrated circuits, process variation tends to increase. Variations that need to be taken into account during the operation of semiconductor integrated circuit include a process variation, a power supply voltage variation, a temperature variation, etc. When a total variation that combines all these variations is considered, the longest delay of signal propagation in a semiconductor integrated circuit may be several times longer than the shortest delay. In order to ensure that semiconductor integrated circuits properly operate despite such large variation, the design process of the semiconductor integrated circuits becomes complex, and the number of process steps increases.

As for the environment in which semiconductor integrated circuits operate, the semiconductor integrated circuit may be required of proper operation in a wide temperature range. If proper operation is required in a wide temperature range from −40° C. to 125° C., a timing margin for −40° C. needs to be secured during the designing of the semiconductor integrated circuits, and, further, an actual field test needs to be conducted for the manufactured semiconductor integrated circuits to check their operations. The designing and field tests to ensure proper operation under such severe temperature conditions as −40° C. require a large number of steps and a great amount of labor and time.

Despite such problems, a current designing process first sets a tolerable power supply voltage range and tolerable ambient temperature range, and the upper end and lower end of a total variation are derived by taking into account process variation in addition to these tolerable ranges, followed by designing a circuit that properly operates under all the conditions that fall within the derived range of variation. Accordingly, a large amount of labor and time needs to be spent designing and manufacturing semiconductor integrated circuit.

As an additional problem, a guaranteed temperature range of an IP macro provided from an IP vendor sometimes does not include −40° C. that is required for the system, and may only guarantee proper operation up to 0° C. In such a case, the system that uses this IP macro may be used in an operation condition of −40° C. by taking a risk of suffering a possible malfunction, or a choice may be made so as not to use the system at all at −40° C.

[Patent Document 1] Japanese Patent Application Publication No. 2004-6473

[Patent Document 2] Japanese Patent Application Publication No. 2004-221157

[Patent Document 3] Japanese Patent Application Publication No. 2003-188062

Accordingly, there is a need for a semiconductor integrated circuit and system that can guarantee proper operation under low-temperature conditions, and that allow a design time to be shortened.

### SUMMARY OF THE INVENTION

It is a general object of the present invention to provide a semiconductor integrated circuit and system that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a semiconductor integrated circuit and system particularly pointed out in the specification in such full, clear, concise, and exact terms as to enable a person having ordinary skill in the art to practice the invention.

To achieve these and other advantages in accordance with the purpose of the invention, the invention provides a semiconductor integrated circuit, which includes a measurement circuit configured to detect a measuring quantity dependent on temperature, and a heating circuit configured to generate heat in response to a detection, by the measurement circuit, of the measuring quantity indicating that the temperature is lower than a predetermined level.

According to another aspect of the present invention, a circuit system includes a first semiconductor integrated circuit including a first measurement circuit configured to detect a measuring quantity dependent on first temperature and a first heating circuit configured to generate heat in response to a detection, by the first measurement circuit, of the measuring quantity indicating that the first temperature is lower than a predetermined level, and a second semiconductor integrated circuit including a second measurement circuit configured to detect a measuring quantity dependent on second temperature and a second heating circuit configured to generate heat in response to a detection, by the second measurement circuit, of the measuring quantity indicating that the second temperature is lower than the predetermined level, wherein a core circuit of the first semiconductor integrated circuit and a core circuit of the second semiconductor integrated circuit are configured to start operating in response to simultaneous detections, by the first measurement circuit and the second measurement circuit, of measuring quantities indicating that the first temperature is higher than the predetermined level and that the second temperature is higher than the predetermined level.

According to another aspect of the present invention, a circuit system includes a first semiconductor integrated circuit, a second semiconductor integrated circuit, a first measurement circuit configured to measure a temperature of the first semiconductor integrated circuit, a second measurement circuit configured to measure a temperature of the second semiconductor integrated circuit, a heating device configured to heat the first semiconductor integrated circuit in response to a detection by the first measurement circuit that the temperature of the first semiconductor integrated circuit is lower than a predetermined level, and a heating device configured to heat the second semiconductor integrated circuit in response to a detection by the second measurement circuit that the temperature of the second semiconductor integrated circuit is lower than the predetermined level, wherein the first semiconductor integrated circuit and the second semiconductor integrated circuit are configured to start operating in response to simultaneous detections by the first measurement circuit and the second measurement circuit that the temperature of the first semiconductor integrated circuit is higher than the predetermined level and that the temperature of the second semiconductor integrated circuit is higher than the predetermined level.

According to another aspect of the present invention, a method of driving a semiconductor integrated circuit includes detecting a measuring quantity dependent on a temperature of a semiconductor integrated circuit, heating the semiconductor integrated circuit in response to a detection of the measuring quantity indicating that the temperature is lower than a predetermined level, stopping heating the semiconductor integrated circuit in response to a detection of the measuring quantity indicating that the temperature is higher than the predetermined level, and causing the semiconductor integrated circuit to start operating in response to a detection of the measuring quantity indicating that the temperature is higher than the predetermined level.

According to at least one embodiment of the present invention, the operation (regular operation) of the semiconductor integrated circuit intended for its original purpose is started after the semiconductor integrated circuit is set to a properly-operable temperature. With such provision, it is possible to shorten the design time for the semiconductor integrated circuit while securing proper operation under low-temperature conditions. Even if low-temperature conditions are not supported by an IP macro, there is no problem since the regular operation of the semiconductor integrated circuit is started after Tj is increased to the temperature at which the IP macro can properly operate.

### BRIEF DESCRIPTION OF THE DRAWINGS

Other objects and further features of the present invention will be apparent from the following detailed description when read in conjunction with the accompanying drawings, in which:

FIG. 1 is a drawing showing the circuit configuration of a first embodiment of a circuit system according to the present invention;

FIG. 2 is a drawing showing an example of the configuration of a frequency comparing circuit and a temperature-measurement-purpose ring oscillator;

FIG. 3 is a flowchart showing the procedure of the heating process performed in the system; and

FIG. 4 is a drawing showing the circuit configuration of a second embodiment of a circuit system according to the present invention.

### DESCRIPTION OF THE PREFERRED EMBODIMENTS

Even under a low-temperature condition such as −40° C., upon the start of operation of a semiconductor integrated circuit in response to a power-on, Tj (i.e., the junction temperature of the semiconductor) increases in a relatively short time period after the start of the operation due to the consumption of electric power associated with the operation of the semiconductor integrated circuit. Once Tj is sufficiently high, Tj does not drop so much as to reach an ambient temperature of −40° C. unless the consumption of power continues due to the continuation of the operation of the semiconductor integrated circuit. Namely, once Tj is sufficiently high, the operating temperature of the semiconductor integrated circuit is kept at temperature higher than the ambient temperature, so that there is no need to design the semiconductor integrated circuit such as to be operable under low-temperature conditions.

In consideration of this, according to the present invention, a temperature-dependent measuring quantity is measured prior to the start of the operation of a semiconductor integrated circuit. If the measuring quantity indicates that the temperature is lower than a predetermined temperature, a heating mechanism is activated in response thereto to increase the temperature of the semiconductor integrated circuit, and waits for Tj to reach a predetermined temperature such as 0° C. or 20° C. Upon detecting that Tj has reached the predetermined temperature, the semiconductor integrated circuit is reset, and the regular operation of the semiconductor integrated circuit is started from that point in time.

With such provision, the temperature range of Tj in which the semiconductor integrated circuit needs to guarantee proper operation can be narrowed, thereby contributing to reducing a total variation. Accordingly, it is possible to shorten the design time for the semiconductor integrated circuit while securing proper operation under low-temperature conditions. Even if low-temperature conditions are not supported by an IP macro, there is no problem since the regular operation of the semiconductor integrated circuit is started after Tj is increased to the temperature at which the IP macro can properly operate.

The heating mechanism for increasing the temperature of the semiconductor integrated circuit may be provided inside the semiconductor integrated circuit chip, or may be provided outside the semiconductor integrated circuit chip. A heating mechanism inside the chip may be an inverter loop laid out throughout the chip for the purpose of increasing temperature, such that heat is generated by driving the loop. Alternatively, clock-signal paths for use in the regular operation may be driven to generate heat for the purpose of increasing temperature. A heating mechanism provided outside the chip may be a heat pipe or Peltier device, for example.

In the following, embodiments of the present invention will be described with reference to the accompanying drawings.

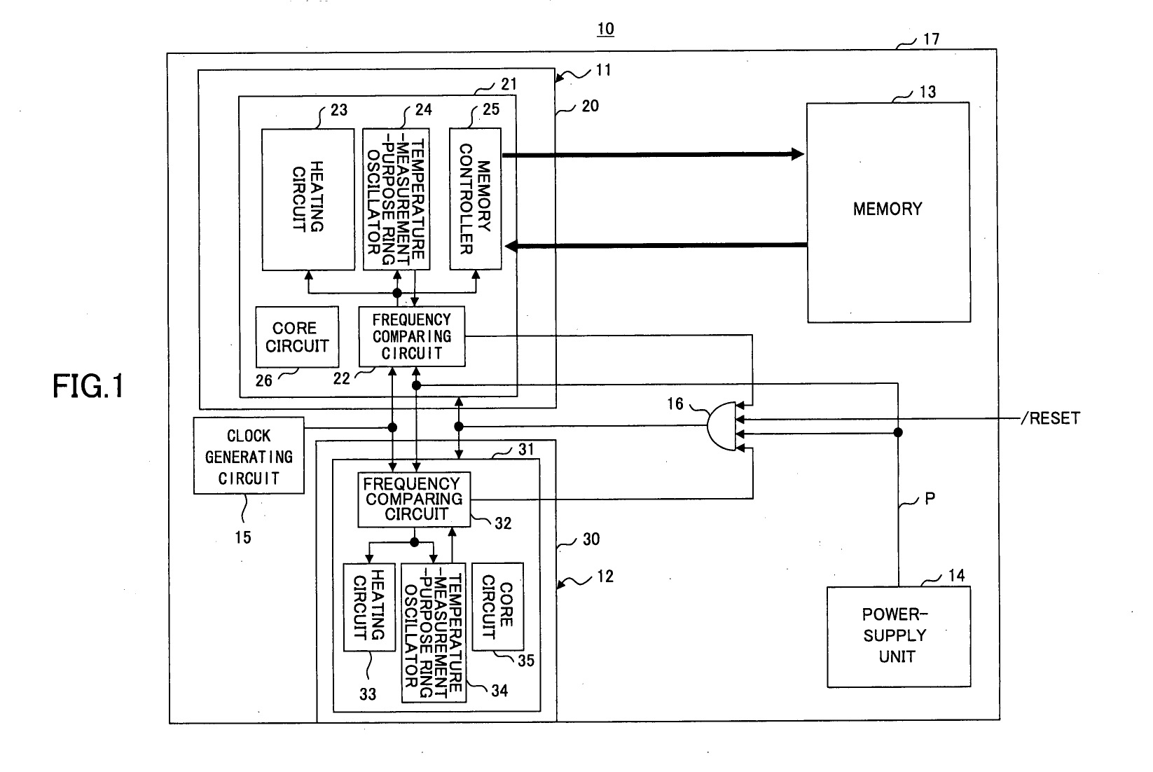

FIG. 1 is a drawing showing the circuit configuration of a first embodiment of a circuit system according to the present invention.

The system 10 of FIG. 1 includes a semiconductor device 11, a semiconductor device 12, a memory 13, a power-supply unit 14, a clock generating circuit 15, and an AND gate 16. The semiconductor device 11, the semiconductor device 12, the memory 13, the power-supply unit 14, the clock generating circuit 15, and the AND gate 16 are implemented on a printed circuit board 17.

The semiconductor device 11 includes a semiconductor integrated circuit 21 (silicon die) encased in a package 20. The semiconductor integrated circuit 21 includes a frequency comparing circuit 22, a heating circuit 23, a temperature-measurement-purpose ring oscillator 24, and a memory controller 25. The frequency comparing circuit 22, the heating circuit 23, and the temperature-measurement-purpose ring oscillator 24 are provided as dedicated circuits for the purpose of measuring temperature and performing a heating process. The semiconductor integrated circuit 21 further includes a core circuit 26 for the purpose of carrying out an intended operation (regular operation) of the semiconductor integrated circuit 21.

The semiconductor device 12 includes a semiconductor integrated circuit 31 (silicon die) encased in a package 30. The semiconductor integrated circuit 31 includes a frequency comparing circuit 32, a heating circuit 33, and a temperature-measurement-purpose ring oscillator 34. The frequency comparing circuit 32, the heating circuit 33, and the temperature-measurement-purpose ring oscillator 34 are provided as dedicated circuits for the purpose of measuring temperature and performing a heating process. The semiconductor integrated circuit 31 further includes a core circuit 35 for the purpose of carrying out an intended operation (regular operation) of the semiconductor integrated circuit 31.

In the system 10, the frequency comparing circuit 22 of the semiconductor device 11 compares the frequency of an oscillating signal generated by the temperature-measurement-purpose ring oscillator 24 and the frequency of a clock signal supplied from the clock generating circuit 15. If the frequency of the oscillating signal of the temperature-measurement-purpose ring oscillator 24 is higher than the frequency of the clock signal of the clock generating circuit 15, the frequency comparing circuit 22 asserts a signal for requesting heating to the heating circuit 23 and the memory controller 25. If the frequency of the oscillating signal of the temperature-measurement-purpose ring oscillator 24 becomes lower than the frequency of the clock signal of the clock generating circuit 15, the frequency comparing circuit 22 negates the signal for requesting heating, and changes a signal indicative of proper temperature condition to HIGH for provision to the AND gate 16. The signal indicative of proper temperature condition is configured not to become HIGH unless the frequency of the oscillating signal of the temperature-measurement-purpose ring oscillator 24 becomes lower than the frequency of the clock signal of the clock generating circuit 15.

It is generally known that the switching speed of a transistor element decreases with a temperature increase. If the oscillating frequency of the temperature-measurement-purpose ring oscillator 24 is higher than a predetermined frequency, thus, it is ascertained that the temperature of the semiconductor device 11 is lower than a predetermined temperature. If the oscillating frequency of the temperature-measurement-purpose ring oscillator 24 is lower than a predetermined frequency, on the other hand, it is ascertained that the temperature of the semiconductor device 11 is higher than a predetermined temperature. Utilizing such check criteria, if the frequency of the oscillating signal of the temperature-measurement-purpose ring oscillator 24 is higher than the frequency of the clock signal of the clock generating circuit 15, the heating circuit 23 is activated to heat the semiconductor device 11, and the memory controller 25 drives the memory 13 to increase the temperature of the memory 13.

The heating circuit 23 responds to the assertion of the signal for requesting heating from the frequency comparing circuit 22 by performing a heating process. The heating circuit 23 may be an inverter loop laid out throughout the chip for the purpose of increasing temperature, or may utilize the clock-signal paths for use in the regular operation so as to utilize such paths for the purpose of increasing temperature. The heating process by the heating circuit 23 refers to the act of causing signals alternating between HIGH and LOW to propagate through the loop in the case of the inverter loop, and refers to the act of causing a clock signal to propagate through the signal paths in the case of the clock-signal paths.

Since the inverter loop is laid out throughout the chip, the entirety of the chip will be heated as each inverter of the inverter loop consumes an electric current by switching its output. In most cases, the clock-signal paths are laid out across the entirety of the chip due to the nature of a clock signal that the clock signal is used at many different points. It is generally known that the clock system consumes one third to half of the electric power consumed by the entirety of the chip during the regular operation. Making the clock-signal paths operate, therefore, provides an effect of heating the entirety of the chip.

The frequency comparing circuit 32, the heating circuit 33, and the temperature-measurement-purpose ring oscillator 34 of the semiconductor device 12 performs the same operations as the frequency comparing circuit 22, the heating circuit 23, and the temperature-measurement-purpose ring oscillator 24 of the semiconductor device 11.

The memory controller 25 responds to the assertion of the signal for requesting heating from the frequency comparing circuit 22 by keeping performing a dummy access or the like with respect to the memory 13. This increases the temperature of the memory 13. The command repeatedly supplied from the memory controller 25 to the memory 13 on a continuous basis may be a refresh command or a read command, for example. In response to refresh commands or read commands repeatedly supplied from the memory controller 25, the memory 13 performs refresh operations or read operations repeatedly so as to consume electric currents inside the memory 13, thereby increasing the temperature of the core circuit.

The reason why the refresh operations or dummy access operations are repeatedly performed by providing commands from the semiconductor device 11 to the memory 13 on a continuous basis is because the memory 13 is devoid of a circuit for measuring temperature and a circuit specifically designed for the heating purpose. Accordingly, there is a need to make the memory 13 operate under the control of the semiconductor device 11 so as to increase the temperature of the memory 13.

The power-supply unit 14 is mounted on the printed circuit board 17, and supplies a predetermined power supply voltage as an output voltage. As the output voltage is stabilized to an intended voltage, the power-supply unit 14 changes a signal P indicative of power-supply-stabilized state to HIGH. The power-supply-stabilized-state indicating signal P is supplied to the frequency comparing circuit 22 of the semiconductor device 11, the frequency comparing circuit 32 of the semiconductor device 12, and the AND gate 16.

The clock generating circuit 15 is mounted on the printed circuit board 17, and supplies a clock signal with which the semiconductor device 11 and the semiconductor device 12 operate. The clock generating circuit 15 may be a circuit utilizing a quartz oscillator, for example, which generates a clock signal oscillating at highly-precise oscillating frequency by utilizing a resonating effect of a crystal oscillator. In this case, the temperature dependency of the oscillating frequency of a quartz oscillator is far smaller than the temperature dependency of the oscillating frequency of the temperature-measurement-purpose ring oscillator 24, the generated clock signal can be used as a reference frequency for use in the temperature check.

The AND gate 16 receives a reset signal /RESET from an exterior, the signal indicative of proper temperature condition from the frequency comparing circuit 22, the signal indicative of proper temperature condition from the frequency comparing circuit 32, and the power-supply-stabilized-state indicating signal P from the power-supply unit 14. The output of the AND gate 16 becomes HIGH if the reset signal /RESET (“/” indicates a negative logic) is HIGH to indicate a reset canceled state, if the signal indicative of proper temperature condition supplied from the frequency comparing circuit 22 is HIGH to indicate a proper temperature for the semiconductor device 11, if the signal indicative of proper temperature condition supplied from the frequency comparing circuit 32 is HIGH to indicate a proper temperature for the semiconductor device 12, and if the power-supply-stabilized-state indicating signal P supplied from the power-supply- unit 14 is HIGH to indicate a stabilized state of the generated power supply voltage.

The output of the AND gate 16 is coupled to the reset input of the semiconductor integrated circuit 21 and the semiconductor integrated circuit 31. If the output of the AND gate 16 is low, the semiconductor integrated circuit 21 and the semiconductor integrated circuit 31 are placed in a reset state. It should be noted that even when the semiconductor integrated circuit 21 and the semiconductor integrated circuit 31 are in the reset state, only the core circuit 26 and the core circuit 35 for performing the intended operation (regular operation) of the semiconductor integrated circuit 21 and the semiconductor integrated circuit 31 are placed in the reset state, while the frequency comparing circuit, the heating circuit, and the temperature-measurement-purpose ring oscillator are placed in an operating state. When the output of the AND gate 16 is changed to HIGH as described above, the core circuit 26 of the semiconductor integrated circuit 21 and the core circuit 35 of the semiconductor integrated circuit 31 exit from the reset state to start performing a normal operation (regular operation).

In the system 10 as described above, the frequency of the oscillating signal of the temperature-measurement-purpose ring oscillator is higher than the frequency of the clock signal of the clock generating circuit 15 immediately after the power-on, so that a heating process is performed to heat the semiconductor device 11, the semiconductor device 12, and the memory 13. When the temperature of the semiconductor device 11 and semiconductor device 12 is increased to a proper temperature so that the frequency of the oscillating signal of the temperature-measurement-purpose ring oscillator becomes lower than the frequency of the clock signal of the clock generating circuit 15, the heating process comes to a halt, and the core circuits of the semiconductor devices 11 and 12 exit from the reset state. Accordingly, the system 10 starts its operation (regular operation) intended for its system function after each semiconductor integrated circuit is set to a properly-operable temperature. Accordingly, it is possible to shorten the design time for the semiconductor integrated circuit while securing proper operation under low-temperature conditions.

In the configuration shown in FIG. 1, the system is configured such that the semiconductor device 11, the semiconductor device 12, and the memory 13 are implemented on the printed circuit board 17. The number of semiconductor devices included in the system is not limited to this example, and may be any number. The system may be configured such that only the semiconductor device 11 is provided. In this case, provision may be made such that the core circuit 26 of the semiconductor device 11 starts its operation in response to the HIGH state of the signal indicative of proper temperature condition supplied from the frequency comparing circuit 22 of the semiconductor device 11.

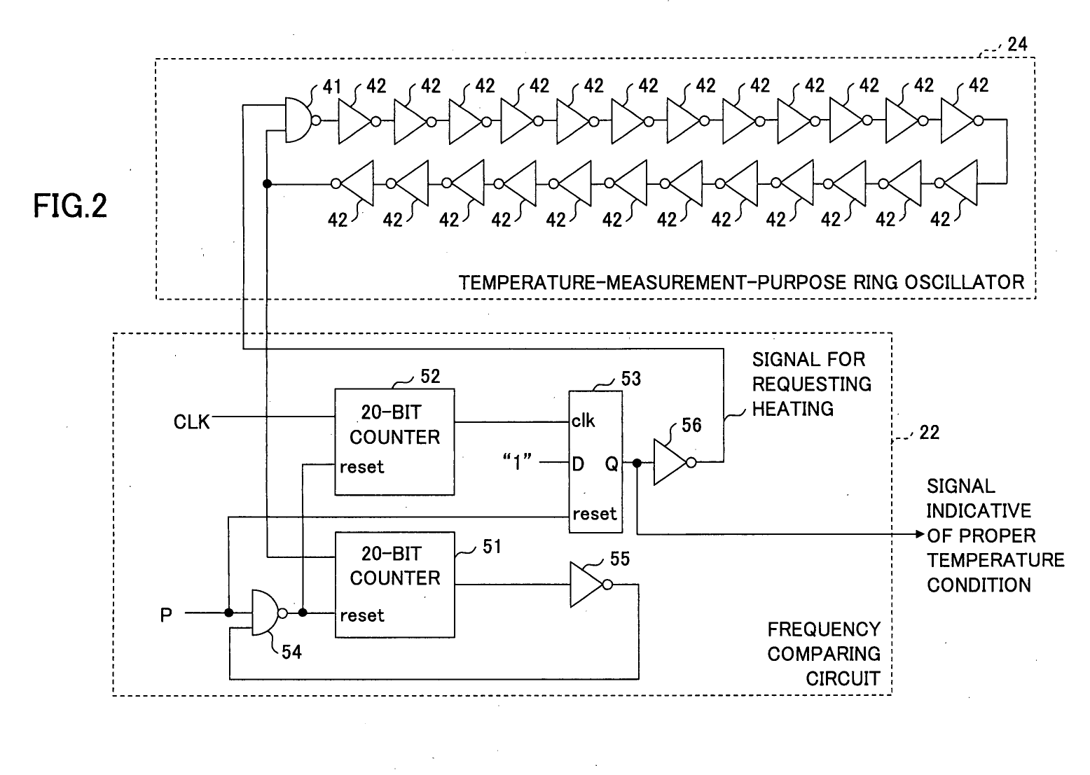

FIG. 2 is a drawing showing an example of the configuration of the frequency comparing circuit 22 and temperature-measurement-purpose ring oscillator 24 of the semiconductor integrated circuit 21. The frequency comparing circuit 32 and temperature-measurement-purpose ring oscillator 34 of the semiconductor integrated circuit 31 may have the same configuration as shown in FIG. 2.

The temperature-measurement-purpose ring oscillator 24 shown in FIG. 2 includes a NAND gate 41 and a plurality of inverters 42. When the signal for requesting heating supplied from the frequency comparing circuit 22 to the NAND gate 41 is HIGH, the NAND gate 41 serves as an inverter. In this case, the temperature-measurement-purpose ring oscillator 24 is configured such that the number of inverters connected in series to form the ring is an odd number. Adjustment of the number of inverters makes it possible to adjust the frequency of the oscillating signal of the ring oscillator.

In this embodiment, provision may be made such that the frequency of the oscillating signal of the ring oscillator is identical to the frequency of the clock signal of the clock generating circuit 15 under the best process condition (i.e., the process condition achieving the fastest signal propagation speed), the typical power-supply-voltage condition, and the condition of Tj=0° C., for example. With this provision, if the frequency of the temperature-measurement-purpose ring oscillator 24 drops below the frequency of the clock signal of the clock generating circuit 15, it is ascertained for certain that Tj is higher than 0° C. under the typical power-supply-voltage condition.

The frequency comparing circuit 22 includes a counter 51, a counter 52, a flip-flop 53, a NAND gate 54, an inverter 55, and an inverter 56. The counter 52 receives the clock signal CLK generated by the clock generating circuit 15, and counts the number of pulses of the clock signal CLK. Namely, the counter 52 counts up its count in synchronization with each pulse of the clock signal CLK. The counter 51 receives the oscillating signal generated by the temperature-measurement-purpose ring oscillator 24, and counts the number of pulses of the oscillating signal. Namely, the counter 51 counts up its count in synchronization with each pulse of the oscillating signal. Each of the counter 51 and counter 52 may be a 20-bit counter, and changes its output to HIGH upon counting a predetermined number (2 to the power of 20). The counter 51 and counter 52 are reset in response to the HIGH state of the reset input. The counter 53 is reset in response to the LOW state of the reset input.

The power-supply-stabilized-state indicating signal P output from the power-supply unit 14 is supplied to one of the two inputs of the NAND gate 54. The power-supply-stabilized-state indicating signal P is also supplied to the reset input of the flip-flop 53. When the power-supply-stabilized-state indicating signal P is LOW, the flip-flop 53 is in the reset state, with its Q output being fixed to LOW. In this case, thus, the signal indicative of proper temperature condition (i.e., the signal to be supplied to the AND gate 16) is fixed to LOW. Further, the output of the NAND gate 54 is fixed to HIGH, so that the counter 51 and counter 52 are in the reset state.

As the power-supply-stabilized-state indicating signal P becomes HIGH, the output of the NAND gate 54 is changed to LOW, so that the counter 51 and counter 52 start their counting operations. With this, the comparison of frequencies by the frequency comparing circuit 22 starts. As the counter 51 counts the pulses of the oscillating signal of the temperature-measurement-purpose ring oscillator 24 so that the count reaches a predetermined number, the output of the counter 51 becomes HIGH. In response to this HIGH, the output of the inverter 55 becomes LOW, so that the output of the NAND gate 54 becomes HIGH. In response, the counter 51 and counter 52 are reset, with their counts returning to zero, followed by the counting operations starting from zero again.

If the frequency of the oscillating signal of the temperature-measurement-purpose ring oscillator 24 is higher than the frequency of the clock signal CLK, the counter 51 reaches the predetermined count before the counter 52 does, resulting in the counters 51 and 52 being reset. In this case, the counter 52 never reaches the predetermined count.

As the temperature of the semiconductor device 11 gradually increases, the frequency of the oscillating signal of the temperature-measurement-purpose ring oscillator 24 gradually decreases. When the frequency of the oscillating signal of the temperature-measurement-purpose ring oscillator 24 becomes lower than the frequency of the clock signal CLK, the counter 52 reaches the predetermined count before the counter 51 does, resulting in the output of the counter 52 being HIGH. The HIGH state of the output of the counter 52 serves as a trigger to cause the flip-flop 53 to load the data “1”. As a result, the Q output of the flip-flop 53 becomes HIGH, so that the signal indicative of proper temperature condition becomes HIGH, informing of the attainment of proper temperature. Further, as the Q output of the flip-flop 53 becomes HIGH, the signal for requesting heating that is the output of the inverter 56 becomes LOW. When the signal for requesting heating becomes LOW, the oscillating operation of the temperature-measurement-purpose ring oscillator 24 is suspended, and the operation of the heating circuit 23 shown in FIG. 1 and the dummy access operation of the memory controller 25 come to a halt.

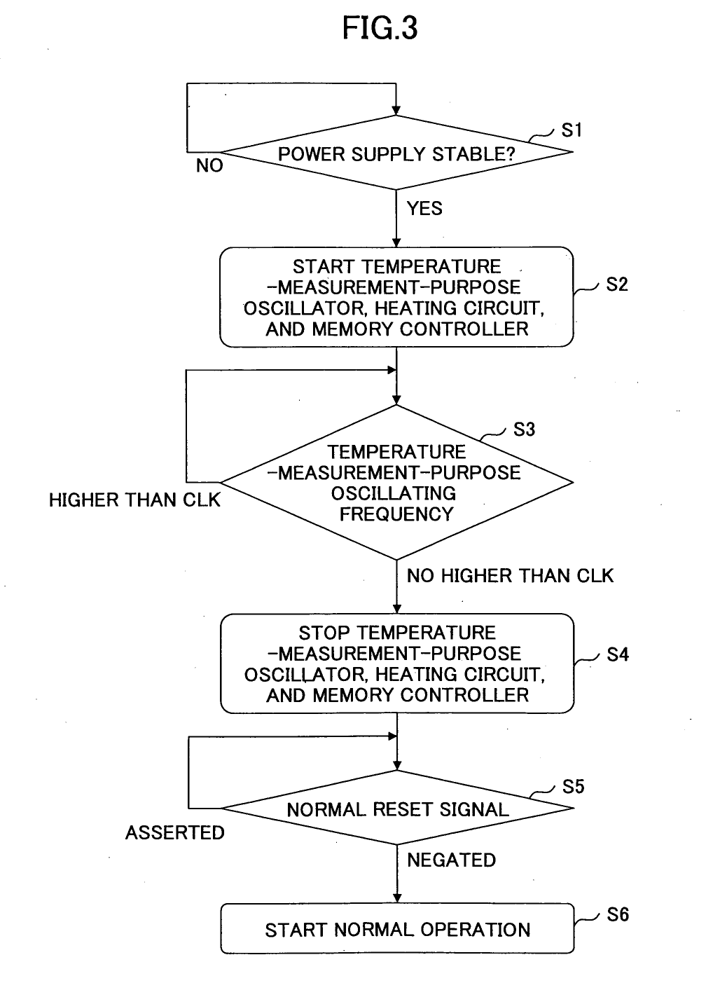

FIG. 3 is a flowchart showing the procedure of the heating process performed in the system 10.

At step S1, a check is made as to whether the power supply is in a stable state. Namely, a check is made as to whether the power-supply-stabilized-state indicating signal P output from the power-supply unit 14 is HIGH or LOW. If the power supply is not in the stable state, step S1 is repeated to wait until the stable power supply state is attained. When the stable power supply state is attained, the procedure goes to step S2.

At step S2, the oscillating operation of the temperature-measurement-purpose ring oscillator, the heating process of the heating circuit, and the memory heating operation of the memory controller are started. Namely, the signal for requesting heating supplied from the frequency comparing circuit to the temperature-measurement-purpose ring oscillator, the heating circuit, and the memory controller is asserted.

At step S3, a check is made as to whether the frequency of the oscillating signal of the temperature-measurement-purpose ring oscillator is lower than that of the clock signal CLK, or higher than that of the clock signal CLK. If it is higher than that of the clock signal CLK, step S3 is repeated since the temperature of the semiconductor integrated circuit has not reached a proper temperature, waiting until the semiconductor integrated circuit reaches a proper temperature. When the frequency of the oscillating signal of the temperature-measurement-purpose ring oscillator becomes lower than that of the clock signal CLK, the procedure goes to step S4.

At step S4, the oscillating operation of the temperature-measurement-purpose ring oscillator, the heating process of the heating circuit, and the memory heating operation of the memory controller are stopped. Namely, the signal for requesting heating supplied from the frequency comparing circuit to the temperature-measurement-purpose ring oscillator, the heating circuit, and the memory controller is negated.

At step S5, a check is made as to whether a normal reset signal is in the asserted state or the negated state. Namely, the AND gate 16 checks whether the reset signal /RESET externally provided as shown in FIG. 1 is in the asserted state or in the negated state. If the reset signal /RESET is in the asserted state, step S5 is repeated to wait until the negated state is attained. When the reset signal /RESET is placed in the negated state, the procedure goes to step S6.

At step S6, the routine operation is started. Namely, the intended operation (regular operation) of the system 10 shown in FIG. 1 is started. Specifically, as the output of the AND gate 16 is changed to HIGH, the core circuit 26 of the semiconductor integrated circuit 21 and the core circuit 35 of the semiconductor integrated circuit 31 exit from the reset state to start performing a normal operation (regular operation).

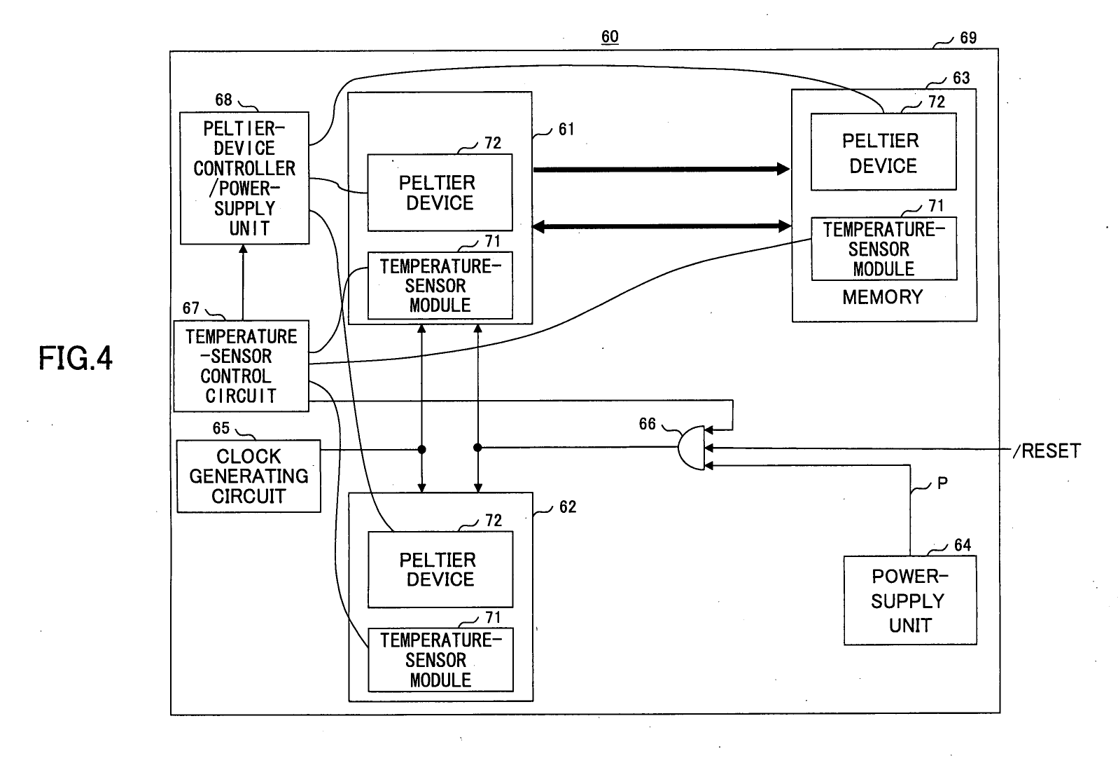

FIG. 4 is a drawing showing the circuit configuration of a second embodiment of a circuit system according to the present invention.

The system 60 of FIG. 4 includes a semiconductor device 61, a semiconductor device 62, a memory 63, a power-supply unit 64, a clock generating circuit 65, an AND gate 66, a temperature-sensor control circuit 67, and a Peltier-device controller/power-supply unit 68. The semiconductor device 61, the semiconductor device 62, the memory 63, the power-supply unit 64, the clock generating circuit 65, the AND gate 66, the temperature-sensor control circuit 67, and the Peltier-device controller/power-supply unit 68 are implemented on a printed circuit board 69.

The semiconductor device 61 includes a semiconductor integrated circuit encased in a package, a surface of which has a Peltier device 72 attached thereto. The Peltier device 72 is a device that utilizes the Peltier effect, by which the conduction of an electric current through a junction of two different metals causes heat to move from one of the metals to the other metal. The Peltier device 72 can move heat from one surface of the sheet-like device to the other surface. Reversal of the direction of the electric current applied to the Peltier device 72 changes the direction of heat shift, thereby switching between the heating and cooling of the semiconductor device 61. The surface of the package of the semiconductor device 61 also has a temperature-sensor module 71 attached thereto. The temperature-sensor module 71 measures the temperature of the package surface, and supplies a signal indicative of the result of temperature measurement to the temperature-sensor control circuit 67.

Like the semiconductor device 61, the semiconductor device 62 includes a semiconductor integrated circuit encased in a package, a surface of which has the temperature-sensor module 71 and the Peltier device 72 attached thereto. The temperature-sensor module 71 measures the temperature of the package surface of the semiconductor device 62, and supplies a signal indicative of the result of temperature measurement to the temperature-sensor control circuit 67.

Like the semiconductor devices 61 and 62, the memory 63 includes a semiconductor integrated circuit encased in a package, a surface of which has the temperature-sensor module 71 and the Peltier device 72 attached thereto. The temperature-sensor module 71 measures the temperature of the package surface of the memory 63, and supplies a signal indicative of the result of temperature measurement to the temperature-sensor control circuit 67.

The temperature-sensor control circuit 67 controls the Peltier-device controller/power-supply unit 68 in response to the signals indicative of the result of temperature measurement supplied from the temperature-sensor modules 71 of the semiconductor device 61, the semiconductor device 62, and the memory 63. If the result of temperature measurement indicates a temperature lower than the temperature range necessary for proper operations (i.e., if the result of temperature measurement indicates a temperature lower than a predetermined temperature), the temperature-sensor control circuit 67 controls the Peltier-device controller/power-supply unit 68 to heat the semiconductor integrated circuits by use of the Peltier devices 72. Provision may be made such that the heating operation of the Peltier device 72 responding to the signal indicative of the result of temperature measurement may be performed separately for each semiconductor integrated circuit. If all the results of temperature measurement indicate a temperature necessary for proper operations, the temperature-sensor control circuit 67 changes a signal indicative of proper temperature condition to HIGH for provision to the AND gate 66.

The power-supply unit 64 is mounted on the printed circuit board 69, and supplies a predetermined power supply voltage as an output voltage. As the output voltage is stabilized to an intended voltage, the power-supply unit 64 changes a signal P indicative of power-supply-stabilized state to HIGH. The power-supply-stabilized-state indicating signal P is supplied to the AND gate 66.

The AND gate 66 receives a reset signal /RESET from an exterior, the signal indicative of proper temperature condition from the temperature-sensor control circuit 67, and the power-supply-stabilized-state indicating signal P from the power-supply unit 64. The output of the AND gate 66 becomes HIGH if the reset signal /RESET (“/” indicates a negative logic) is HIGH to indicate a reset canceled state, if the signal indicative of proper temperature condition supplied from the temperature-sensor control circuit 67 is HIGH to indicate a proper temperature for each semiconductor integrated circuit, and if the power-supply-stabilized-state indicating signal P supplied from the power-supply unit 64 is HIGH to indicate a stabilized state of the generated power supply voltage.

The output of the AND gate 66 is coupled to the reset input of the semiconductor device 61 and the semiconductor device 62. If the output of the AND gate 66 is low, the semiconductor device 61 and the semiconductor device 62 are placed in a reset state. When the output of the AND gate 66 is changed to HIGH as described above, the semiconductor device 61 and the semiconductor device 62 exit from the reset state to start performing a normal operation (regular operation).

In the system 60 as described above, the temperatures measured by the temperature-sensor modules 71 are lower than the predetermined temperature immediately after the power-on, so that the process of heating the semiconductor device 61, the semiconductor device 62, and the memory 63 by use of the Peltier devices 72 is performed. Thereafter, as the temperatures of the semiconductor device 61, the semiconductor device 62, and the memory 63 increase to a proper temperature, the heating process comes to a halt, and the semiconductor device 61 and semiconductor device 62 exit from the reset state. Accordingly, the system 60 starts its operation (regular operation) intended for its system function after each semiconductor integrated circuit is set to a properly-operable temperature. Accordingly, it is possible to shorten the design time for the semiconductor integrated circuit while securing proper operation under low-temperature conditions.

As previously described, reversal of the direction of the electric current applied to the Peltier device 72 changes the direction of heat shift, thereby switching between the heating and cooling of the semiconductor device. In the system configuration as shown in FIG. 4, thus, if the temperature becomes higher than the temperature range in which the semiconductor devices are properly operable, the temperature-sensor control circuit 67 may control the Peltier-device controller/power-supply unit 68 such that the Peltier devices 72 are operated to cool the semiconductor devices.

Further, the present invention is not limited to these embodiments, but various variations and modifications may be made without departing from the scope of the present invention.

Although the heating mechanisms described in the above embodiments include a dedicated inverter loop, existing clock-signal paths, and a dedicated Peltier device, the heating mechanism of the present invention is not limited to these examples. For example, a heating-purpose resistor with a switch may be embedded in each semiconductor device. Alternatively, a pattern alternating between “0” and “1” may be made to propagate through a scan path that is provided for the purpose of DFT (Design for Testability). Alternatively, if a self-check-type Loigc-BIST (Built-in Self Test) is provided, a BIST operation may be repeated until the value of the Logic-BIST becomes a correct value. This procedure by which the BIST operation is repeated until the value of the Loigc-BIST becomes a correct value may also be used for the purpose of measuring temperature.

What is claimed is:

1. A semiconductor integrated circuit, comprising:
a measurement circuit configured to detect a measuring quantity dependent on temperature; and
a heating circuit configured to generate heat in response to a detection, by the measurement circuit, of the measuring quantity indicating that the temperature is lower than a predetermined level.

2. The semiconductor integrated circuit as claimed in claim 1, wherein the measurement circuit includes:
a ring oscillator; and
a frequency comparing circuit configured to compare a frequency of a clock signal supplied from an exterior with a frequency of an oscillating signal of the ring oscillator,
wherein the heating circuit is configured to generate heat in response to a detection by the frequency comparing circuit that the frequency of the oscillating signal is higher than the frequency of the clock signal.

3. The semiconductor integrated circuit as claimed in claim 1, wherein the heating circuit is configured to generate heat by consuming an electric current through operations that cause a signal level to alternate between HIGH and LOW.

4. The semiconductor integrated circuit as claimed in claim 1, further comprising a memory controller configured to repeatedly transmits commands to be executed by a memory in response to a detection, by the measurement circuit, of the measuring quantity indicating that the temperature is lower than a predetermined level.

5. The semiconductor integrated circuit as claimed in claim 1, wherein the heating circuit is configured to suspend the generation of heat in response to a detection, by the measurement circuit, of the measuring quantity indicating that the temperature is higher than a predetermined level.

6. The semiconductor integrated circuit as claimed in claim 1, further comprising a core circuit configured to start operating in response to a detection, by the measurement circuit, of the measuring quantity indicating that the temperature is higher than a predetermined level.

7. A circuit system, comprising:
a first semiconductor integrated circuit including a first measurement circuit configured to detect a measuring quantity dependent on first temperature and a first heating circuit configured to generate heat in response to a detection, by the first measurement circuit, of the measuring quantity indicating that the first temperature is lower than a predetermined level; and
a second semiconductor integrated circuit including a second measurement circuit configured to detect a measuring quantity dependent on second temperature and a second heating circuit configured to generate heat in response to a detection, by the second measurement circuit, of the measuring quantity indicating that the second temperature is lower than the predetermined level,
wherein a core circuit of the first semiconductor integrated circuit and a core circuit of the second semiconductor integrated circuit are configured to start operating in response to simultaneous detections, by the first measurement circuit and the second measurement circuit, of measuring quantities indicating that the first temperature is higher than the predetermined level and that the second temperature is higher than the predetermined level.

8. A circuit system, comprising:
a first semiconductor integrated circuit;
a second semiconductor integrated circuit;
a first measurement circuit configured to measure a temperature of the first semiconductor integrated circuit;
a second measurement circuit configured to measure a temperature of the second semiconductor integrated circuit;
a heating device configured to heat the first semiconductor integrated circuit in response to a detection by the first measurement circuit that the temperature of the first semiconductor integrated circuit is lower than a predetermined level; and
a heating device configured to heat the second semiconductor integrated circuit in response to a detection by the second measurement circuit that the temperature of the second semiconductor integrated circuit is lower than the predetermined level,
wherein the first semiconductor integrated circuit and the second semiconductor integrated circuit are configured to start operating in response to simultaneous detections by the first measurement circuit and the second measurement circuit that the temperature of the first semiconductor integrated circuit is higher than the predetermined level and that the temperature of the second semiconductor integrated circuit is higher than the predetermined level.

9. The circuit system as claimed in claim 8, wherein the heating device is a Peltier device.

10. A method of driving a semiconductor integrated circuit, comprising:
detecting a measuring quantity dependent on a temperature of a semiconductor integrated circuit;
heating the semiconductor integrated circuit in response to a detection of the measuring quantity indicating that the temperature is lower than a predetermined level;
stopping heating the semiconductor integrated circuit in response to a detection of the measuring quantity indicating that the temperature is higher than the predetermined level; and
causing the semiconductor integrated circuit to start operating in response to a detection of the measuring quantity indicating that the temperature is higher than the predetermined level.
